(19) United States
(12) Patent Application Publication
(10) Pub. No.: US 2026/0244693 A1
(43) Pub. Date: Aug. 20, 2026

(54) AGENTIC SOCIAL PLATFORM

(71) Applicant: Unified Intelligence LLC, Austin, TX (US)

(72) Inventor: Samvit Ramadurgam, Austin, TX (US)

(21) Appl. No.: 19/541,184

(22) Filed: Feb. 16, 2026

Related U.S. Application Data
(60) Provisional application No. 63/759,490, filed on Feb. 17, 2025.

(51) Int. Cl. G06F 16/9536

(52) U.S. Cl. CPC G06F 16/9536

(57) ABSTRACT

In variants, the method can include determining a social network; determining a knowledge database; receiving an interaction associated with a primary user; determining a set of secondary users for the primary user; and generating a response to the interaction based on the set of secondary users and the knowledge database. The system and/or platform can include a knowledge database, a set of agents, and a user interface, wherein the set of agents can retrieve data from the knowledge database when generating responses to user queries.

### CROSS-REFERENCE TO RELATED APPLICATIONS

This application claims the benefit of US Provisional Application number 63/759,490 filed 17-FEB-2025, which is incorporated in its entirety by this reference.

### TECHNICAL FIELD

This invention relates generally to the data management field, and more specifically to a new and useful relevant content generation system and method in the data management field.

### BRIEF DESCRIPTION OF THE FIGURES

FIG. 1 is a schematic representation of a variant of the method.

FIG. 2 is an illustrative example of a variant of filtering a primary user's social network and querying the knowledge database.

FIGS. 3A-3C are an illustrative example of a variant of receiving a query from a primary user and generating a response to the query.

FIG. 4 is an illustrative example of a variant of a user in a public group chat.

FIGS. 5A-5B are an illustrative example of a variant of querying a primary user’s social network.

FIG. 6 is an illustrative example of generating a response to a user query.

FIG. 7 is an illustrative example of a variant of a user interface of the platform.

FIG. 8 is an illustrative example of a variant of identifying a secondary user with a specific experience within a primary user’s social network.

FIG. 9 is an illustrative example of a variant of a social graph.

FIG. 10 is an illustrative example of a variant of agent interaction.

FIG. 11 is an illustrative example of a variant of central agents and user agents.

FIG. 12 is an illustrative example of a variant of a knowledge database.

FIG. 13 is an illustrative example of a variant of generating a response.

### DETAILED DESCRIPTION

The following description of the embodiments of the invention is not intended to limit the invention to these embodiments, but rather to enable any person skilled in the art to make and use this invention.

### Overview

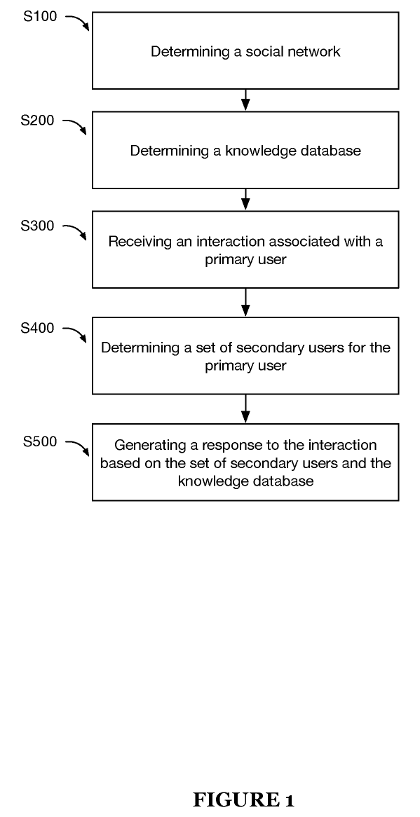

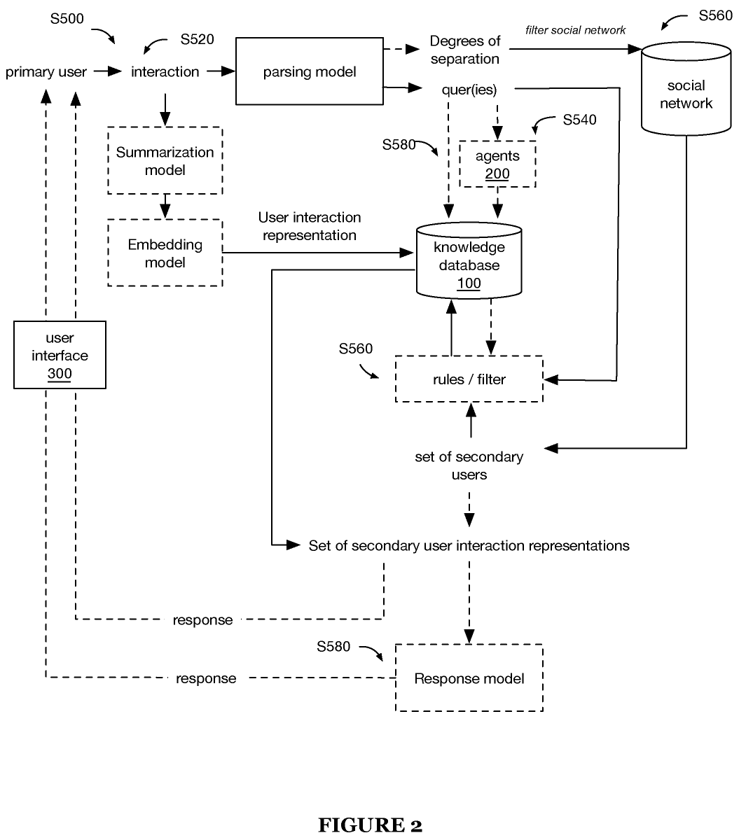

As shown in FIG. 1, in variants, the method can include: determining a social network S100; determining a knowledge database S200; receiving an interaction associated with a primary user S300; determining a set of secondary users for the primary user S400; and generating a response to the interaction based on the set of secondary users and the knowledge database S500. The method functions to provide users with personalized and relevant responses to interactions with the platform, based on their social network. The system and/or platform can include a knowledge database 100, a set of agents 200, and a user interface 300, as shown for example in FIG. 2.

In an illustrative example, the method can, with a platform: determine a user’s social network based on a set of user relationships (e.g., direct connections, indirect connections within N degrees of separation, etc.); create and maintain a knowledge database of user interactions (e.g., of interaction summaries, embeddings, thereof, etc.), each associated with a user identifier (e.g., across all users, across both public and private interactions, etc.); receive an interaction from a primary user; determine a set of secondary users of the primary user associated with the interaction (e.g., degrees of separation, group memberships, etc.); filter the knowledge database to include only content generated by the user and/or the set of secondary users (e.g., optionally filtered based on privacy settings); optionally determine relevant content based on similarity to the interaction (e.g., cosine similarity in embedding space, etc.); optionally query agents associated with the secondary users for information; and generate a response to the interaction based on the filtered social network and relevant summaries. All or a portion of: social network determination, knowledge database generation, secondary user set parameter determination (e.g., determining the number of secondary users, the number of connection degrees, the specific secondary users, etc.), content retrieval from the knowledge database (e.g., filtering, searching, etc.), and/or response generation can be performed by a set of AI agents (e.g., LLMs, transformers, DNNs, etc.), wherein input context and the user interaction (or derivative prompt or query) can be sent to the AI agent for result generation. In variants, privacy constraints may determine whether certain content is presented in full, summarized, anonymized, or not used for response generation. For example, the system may generate a response based on connected users' private posts, without providing the posts themselves or summaries thereof.

In examples, the platform can: respond to user questions based on interactions (e.g., content) from the user's connections; generate summaries for different topics from connected users' interactions; selectively display content generated by connected users within a globally-shared chatroom or forum (e.g., filter out content generated by non-connected users); store public and/or private notes for the user (e.g., generated from direct user interaction with the platform, from inter-user interactions, etc.; function as a journal; etc.); and/or provide other functionalities.

In an illustrative example of the platform, the platform includes a database, a set of agents, and a user interface. The set of agents includes one or more user agents, each of which may be implemented as an instance of a large language model. Users interact with the system through the user interface by providing input (e.g., input data, a query, etc.) to a corresponding user agent. Each user of the system is associated with a respective user agent, wherein the user agent is configured to utilize data associated with the respective user (e.g., via context, context engineering, RAG database, etc.) when generating responses. The data associated with the user can include user data as well as authorized data associated with other users of the platform. For example, users may be connected to other users through a social graph defining first-degree, second-degree, or higher-degree connections. A user agent can be configured to retrieve and utilize data associated with users that are within a predetermined connection degree of the associated user (e.g., first-degree and second-degree connections) to generate responses. Each user agent can further be configured to query other user agents and/or retrieve and filter data from the database to generate a response to a user query. Each window agent can generate notes, summaries, and/or data aggregations based on the user interactions (e.g., user-user interaction, user-agent interactions, etc.) which can be written to the database and used to generate response to user queries.

### Technical advantages

Variants of the technology can confer one or more advantages over conventional technologies.

First, variants of the technology can facilitate more effective and contextually relevant information retrieval relative to conventional data-query methods. By leveraging social network analysis and dual-representation knowledge databases (e.g., containing both raw and embedded content), the system can implement intelligent search scope refinement. For example, the technology can selectively filter and prioritize information based on social proximity parameters (e.g., by considering interactions from users within a predetermined number of network connections from the querying user). This network-aware filtering can enhance query response precision while maintaining access to the broader knowledge corpus. In a specific example, when a user queries technical documentation, the system can prioritize content interactions from their immediate team members and close collaborators, while still retaining the capability to access relevant information from the entire user base. The selective scope refinement can reduce computational overhead compared to exhaustive search methods, while simultaneously improving the contextual relevance of retrieved information. This approach can differ from conventional methods that may either restrict searches to rigid organizational hierarchies or implement overly broad, context-agnostic search parameters.

Second, variants of the technology can improve computational efficiency and response accuracy by generating outputs based on structured notes and summaries rather than directly operating on raw interaction data. Raw user interactions may include noise, redundancy, incomplete information, or irrelevant content, which can increase computational overhead and reduce retrieval precision when used directly. By transforming raw interactions into standardized and/or normalized notes and summaries, the system can operate on cleaner, semantically distilled representations that reduce data volume while preserving relevant meaning. This can lower memory usage, reduce query and inference latency, comply with ML context limits, focus ML attention, and improve the accuracy and consistency of generated responses relative to systems that rely primarily on raw data for retrieval and generation.

Third, variants of the technology use embeddings represented in a latent feature space for encoding semantic information which enable fast, scalable, and accurate filtering. By encoding notes, summaries, and other user data as vector representations, variants of the platform can perform semantic similarity search, clustering, and ranking operations that are robust to noise, variation in phrasing, and inconsistent user-generated content. Latent-space filtering enables efficient identification of semantically related information while avoiding reliance on exact keyword matching, thereby improving retrieval accuracy and stability over time. In addition, embedding-based representations can be combined with metadata-based constraints, such as privacy levels and social proximity, to enable multi-dimensional filtering with reduced computational complexity. This approach further allows cross-user and cross-context generalization using abstracted representations rather than raw data, improving scalability and enabling privacy-preserving analysis as the volume of users and interactions increases.

Fourth, variants of the technology have a multi-agent architecture, in which different agents are configured with distinct contextual scopes and access privileges. In variants, user-specific agents can be instantiated with individualized context windows that are restricted to data associated with a corresponding user and authorized connections, thereby maintaining contextual isolation and preserving user privacy during interaction and response generation. At the same time, in variants the system can include one or more central agents configured with broader contextual access and analytical capabilities, enabling cross-user analysis, large-scale similarity searches, clustering, and coordination across multiple user agents. This separation of responsibilities allows privacy-sensitive reasoning to occur at the user-agent level, while computationally intensive or global analyses are performed by central agents or limited-scope agents without exposing raw user data to other users. As a result, variants of the platform can facilitate meaningful user-user connections and recommendations while enforcing privacy constraints and improving scalability, modularity, and computational efficiency relative to monolithic single-agent systems.

However, further advantages can be provided by the system and method disclosed herein.

### System

As shown in FIG. 2, the system includes a knowledge database 100; a set of agents 200; and a user interface 300. The system functions to provide users with personalized and relevant information to queries based on their social network. The knowledge database 100 functions to store data and/or data representations associated with users of the platform. The user data can include raw user interactions, interaction summaries (e.g., "notes", “summaries”), embeddings of the interactions and/or summaries, and/or any other user data. Examples of raw user interactions can include user personal logs, user-user interactions (e.g., messages), user biographical information, and/or any other suitable data. For example, a raw user interaction can be users messaging other users, users querying an agent and/or model, users inputting personal information, users documenting and/or writing personal notes, or any other suitable interaction.

In variants, summaries and/or notes can be generated based on the raw user interactions (e.g., using the set of agents, using an AI model, etc.). In some variants, notes can be referred to as an "atomic unit of data" utilized by the models and/or agents of the system, while summaries can be aggregations and/or transformations of the notes. Notes can be generated based on raw user interactions in real time, in batches, periodically (e.g., every N interactions, every N minutes, etc.), in a response to a predetermined trigger, and/or at any other time. Summaries can be generated in real-time, after an interaction session, periodically (e.g., every N lines, every N minutes, etc.), in response to a predetermined trigger, and/or at any other time. However, notes and/or summaries can be otherwise structured.

The embeddings can be transformed representations of the interactions, notes, and summaries. In variants, the embeddings can be generated from semantic data (e.g., user interactions, user notes and/or logs, agent-generated notes and/or summaries, semantic agent-generated notes, etc.). In variants, the embeddings can be vector representations of interactions and/or summaries, wherein geometric relationships between vectors correspond to relationships between the data items. The embeddings can be in vector space, latent feature space, multidimensional feature space, a learned latent space, and/or any other suitable space. The embeddings are preferably human-unintelligible (e.g., has no semantic meaning for a human, etc.), but can alternatively be human-readable. The embeddings preferably represent semantic information, but can alternatively represent other information. The embeddings of the interactions and/or summaries can encode information for enabling similarity searches, clustering, anomaly detection, and/or any other function. Embeddings can be determined by machine learning models, mapping functions, artificial intelligence (AI) agents, encoders, and/or any other suitable method.

Each piece of user data can be associated with one or more user identifiers (e.g., for the user that generated the user interaction, for users involved in the user interaction, etc.), a privacy level and/or privacy setting (e.g., public, private, accessible by connections within a predetermined number of degrees, etc.), user interaction metadata (e.g., interaction time, device, topic, data source, data type, etc.), and/or any other associations.

In variants, the privacy level can be data-specific (e.g., such that each datum has a privacy level, etc.), user-specific (e.g., such that data associated with a user has a privacy level), topic-specific (e.g., all data associated with a specific topic has a distinct privacy level), and/or be otherwise specified. In variants, the privacy level can be user-defined, determined by a model and/or agent, automatically assigned based on a policy (e.g., default rules), and/or otherwise determined.

In variants, the data can be input by users, collected by the agents, retrieved from an external source (e.g., via the Internet, from websites, social media, and/or any other external source, etc.), and/or otherwise retrieved. In an example, in variants wherein data is retrieved from external sources, the knowledge database 100 can be configured to automatically retrieve data from a website and/or social media profile associated with the user. The data retrieval from external sources can be performed automatically, in-response to a request, periodically, and/or in any other suitable manner. In a first example, data can be automatically retrieved when initializing a profile on the platform. In a second example, data can be periodically retrieved to ensure all data in the knowledge database 100 is up-to-date.

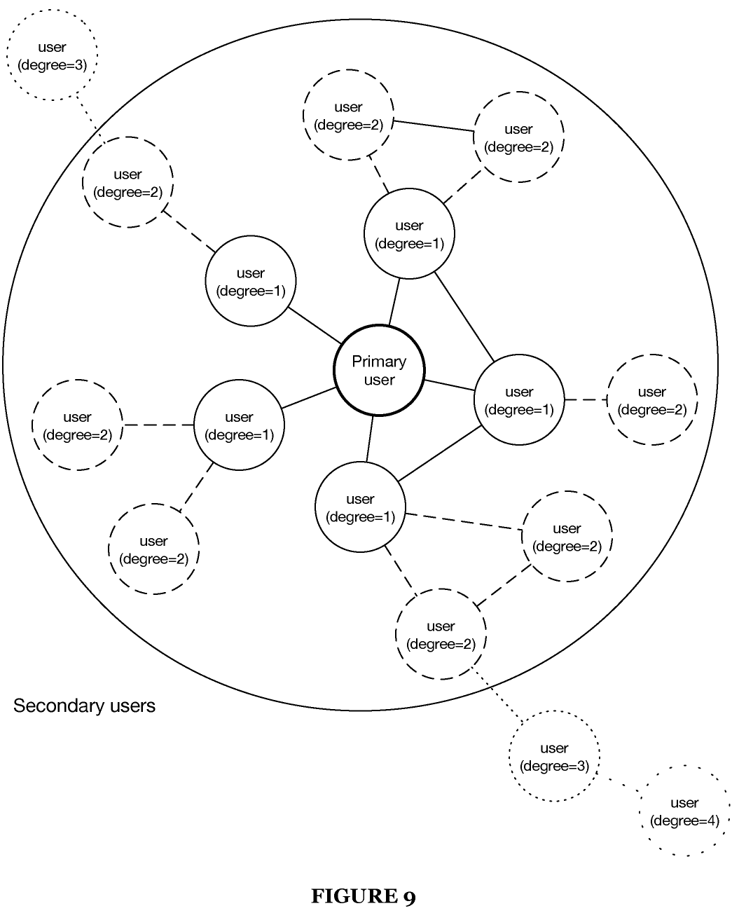

In some variants, the knowledge database 100 can store data related to the social proximity of users of the system (e.g., social graph). In variants, the social proximity information can be stored as tags, as a table, as a graph, and/or in any other suitable format. The social proximity information can include information on whether users have a 1st degree connection (e.g., direct relationship between two entities,), 2nd degree connection (e.g., an indirect relationship via one intermediary user), 3rd degree connection (e.g., an indirect relationship via two intermediary users), and/or any other suitable connections. In a specific example, the social proximity can be depicted as a graph (e.g., where users are nodes and edges describe connections, as shown for example in FIG. 9). In these variants, a 2nd degree connection can be depicted in a graph as a path between 2-users (e.g., nodes) that is 2 edges long. Similarly, a 3rd degree connection can be depicted in a graph as a path between users that is 3 edges long.

The knowledge database 100 can be a monolithic datastore (e.g., monolithic database), segmented datastore (e.g., different databases for different users, different geographic regions, different topics, etc.), and/or otherwise constructed. The knowledge database 100 can be implemented as a distributed set of databases across multiple devices or locations, or alternatively in a singular device and/or location. In a first example, the user data for each user can be stored in storage managed by the respective user (e.g., in user device, in a user repository, and/or any other storage). In a second example, the user data for one or more users can be stored in a platform-managed database. The knowledge database 100 can be implemented as a relational database, a graph database, a key-value store, or a hybrid thereof.

The data records can be associated with user identifiers, temporal parameters, spatial parameters, social proximity values, and/or other metadata to enable efficient querying. The data records and embeddings can be indexed using one or more indexing structures. Examples of indexing structures that can be used can include hash-based, tree-based, graph-based, approximate nearest neighbor indices, and/or any other indexing structures. The knowledge database 100 can support query operations for retrieving data based on identifiers, metadata attributes, similarity metrics, authorization constraints, and/or combinations thereof.

In some variants, frequently accessed data and/or embeddings are cached in memory to reduce query latency and computational load. Access to the knowledge database 100 can be controlled using one or more authorization rules that restrict retrieval of data based on user identity, agent identity, social proximity, privacy levels and/or settings, or any other suitable parameter. The knowledge database 100 can be updated based on user interactions, system feedback, newly received data (e.g., from user input, from automatic retrieval, etc.), and/or any other data, such that stored records evolve over time. In some variants, user data in the knowledge database 100 can be subject to retention rules, expiration policies, or deletion triggers, such that data is automatically archived, anonymized, or removed after a predetermined condition is satisfied.

However, the knowledge database 100 may be otherwise configured.

The set of agents 200 functions to interact with users and other agents and query the database. Each agent of the set of agents 200 is preferably an instance of a neural network, but can alternatively be a rule set, a decision tree, and/or be otherwise configured. The agents can each be instances of the same neural network or can be instances of different neural networks. The neural network is preferably a generative model, convolutional neural network, graph neural network, machine learning model, or any other suitable model. The generative model can be a large language model, a visual language model, a multimodal model, a diffusion model, and/or any other generative model.

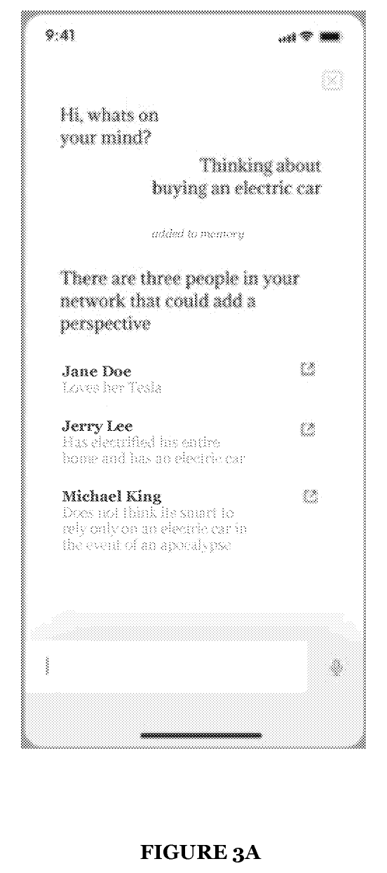

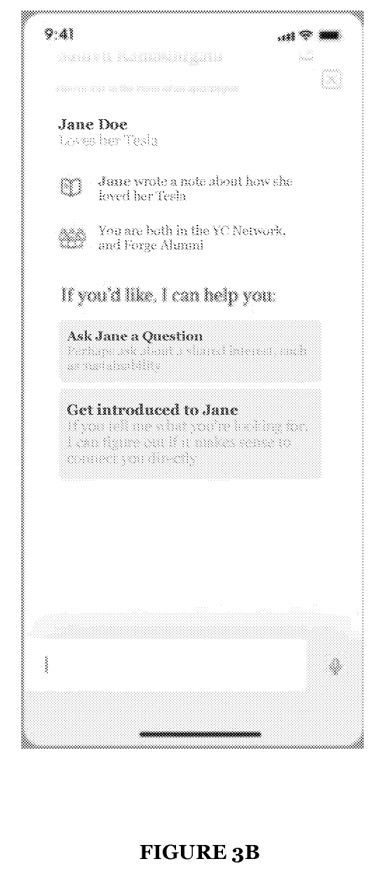

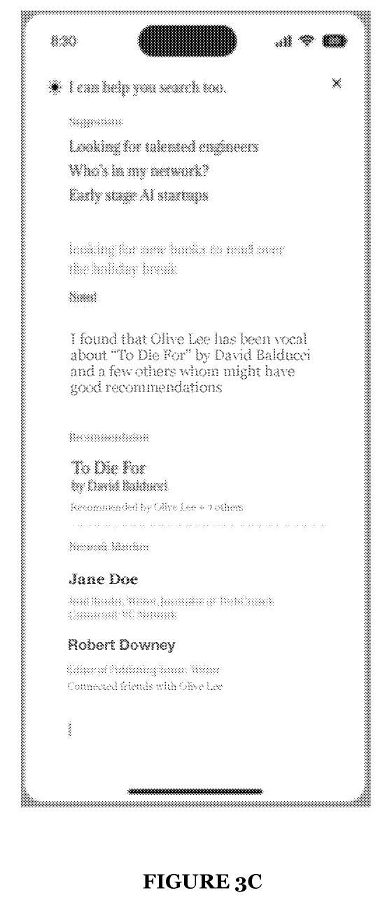

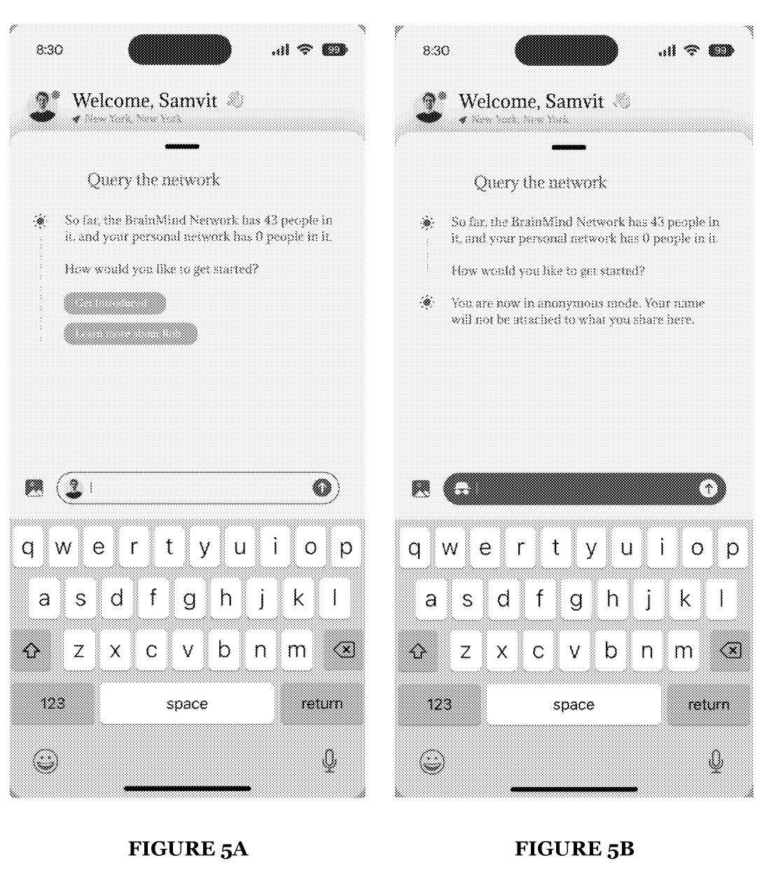

The set of agents can be configured to answer user questions based on the data in the database, make recommendations to the user (e.g., as shown for example in FIG. 3C), suggest user-user interactions (e.g., as shown for example in FIG. 3B), summarize user interactions (e.g., user interactions with the platform, user interactions with other users, etc.), summarize user sentiments, retrieve information and/or data from other users and/or agents (e.g., via message-passing, etc.), query the database (e.g., as shown for example in FIG. 5A and FIG. 5B), retrieve information from the Internet, schedule tasks (e.g., scheduling messaging of users and/or agents, etc.), add events to a calendar, create a chat room, automatically message a user, identify users that share common parameters (e.g., based on the respective private data, without revealing the private data) as shown for example in FIG. 3A, generate content and/or media (e.g., articles, infographs, podcasts, and/or videos associated with users, etc.), and/or perform any other task.

In variants, the set of agents can include parsing models (e.g., for parsing the database), embedding models (e.g., for determining and/or generating embeddings of the data), summarization models (e.g., for determining and/or generating notes and/or summaries of data), data analysis models (e.g., for performing data analysis, queries, similarity searches, data clustering, etc.), conversational and/or response models (e.g., for interacting with users), content generation model (e.g., for generating images, podcasts, videos, infographs, etc.), and/or any other agents.

An agent can be invoked in response to user input, a user query, a system event, a scheduled trigger, output from another agent, and/or otherwise invoked. In variants, a user can provide an agent a question and/or query. The user query can include queries for information, queries for information related to users, queries for information related to a subset of users (e.g., 1st and 2nd degree connections, etc.), queries for recommendations and/or suggestions, and/or any other suitable query type. Input to the set of agents 200 can include text, natural language input, visual data (e.g., image, video, etc.), audio, and/or any other suitable data type.

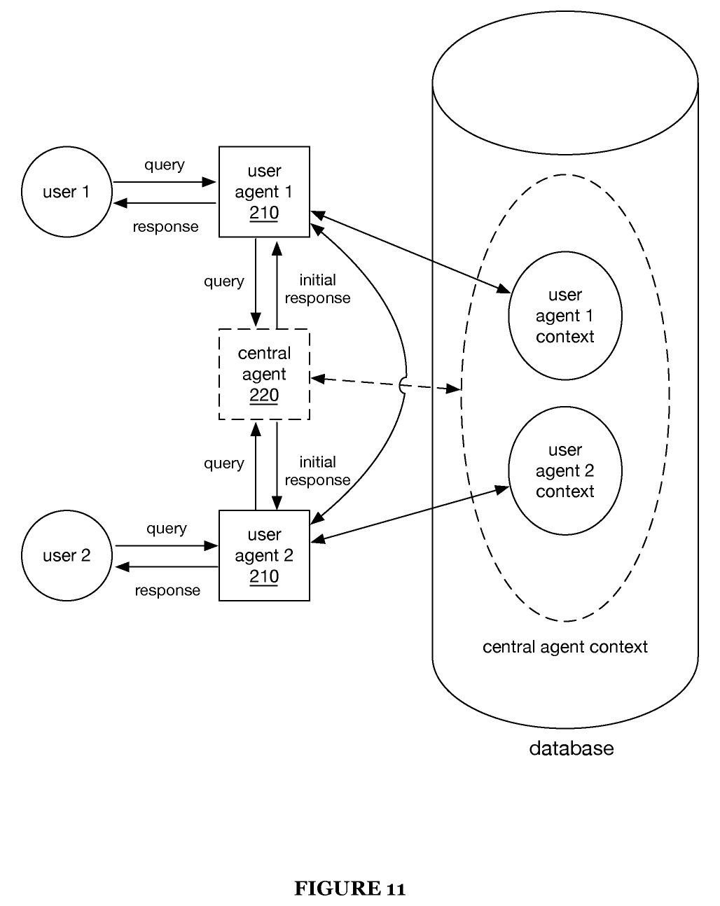

Each agent can be configured with agent-specific parameters, prompts, policies, and/or constraints that govern behavior, access rights, and/or output format. In variants, each agent of the set of agents 200 can maintain an internal state and/or access a memory store including context information, prior interactions, or retrieved data, enabling stateful interactions over time. For example, each agent can have different context and/or prompt engineering (e.g., according to user, according to task, etc.). In variants, the agents can implement retrieval-augmented generation, wherein an agent retrieves relevant data from the database and uses the retrieved data as contextual input when generating an output. In variants, each agent can have a different set of contextual input, as shown for example in FIG. 11.

The retrieved data can include notes, summaries, embeddings, and/or any other authorized user data. In a specific variant, the agents can utilize summaries and/or notes (e.g., agent-generated data representations of raw user data) to generate output and/or responses to queries. For example, in this variant, notes and/or summaries are used as context for generating responses to user queries. In this variant, raw user interactions may not be used to generate responses. This variant can enable more efficient computation, lower memory needs, and more accurate responses. In another variant, the set of agents 200 can utilize summaries, notes, raw data (e.g., raw user interactions), and embeddings to generate output.

In variants, each agent of the set of agents 200 can retrieve relevant data from the database based on a user input and incorporates the retrieved data as context when generating a response. In an example, each agent can generate a query embedding based on the user input, retrieve one or more data items from the database using similarity-based retrieval, and condition a generated output on the retrieved data. In variants, retrieving data can include filtering the data. For example, a similarity-based retrieval and/or any other suitable retrieval can involve filtering the database in latent feature space. In another example, vector embeddings associated with user interactions, notes, and/or summaries can be grouped into clusters (e.g., based on vector similarity, proximity, etc.). These groupings of embeddings can be used to filter the corresponding interactions, notes, and/or summaries. The similarity-based retrieval and/or any other suitable retrieval can involve filtering the database in latent feature space, wherein groups and/or clusters of embeddings can be determined through cosine similarity, Euclidean distance, Manhattan distance, dot product similarity, angular distance, using cluster centroids, k-means clustering, nearest neighbor graph traversal, density-based methods, and/or any other suitable method. However, in other variants, the data can be filtered based on user, generation and/or retrieval date, data type, data source (e.g., from user logs, from user interaction, etc.), topic, and/or any other property or metadata.

In variants, the set of agents 200 can retrieve information from the database based on the social graph. In an example, agents can access data from the database associated with specific users and/or user connections. In a specific variant, the set of agents 200 can utilize data of users associated with a primary user by a threshold social proximity value to generate responses to queries of the primary user. In variants, the context of an agent can be limited to data associated with the primary user and users of a threshold social proximity value (e.g., two or lower, etc.). In specific variants, the set of agents 200 can request a user of data and/or information if there is data missing from the database.

The set of agents 200 can generate responses to user queries based on privacy rules, behavioral settings, learned policy, and/or any other suitable constraints. In a specific example, the set of agents 200 can be configured to restrict and/or hide data associated with users from a primary user based on the social proximity value of the users. For example, the data associated with a user of a social proximity value of three in relation to a primary user (e.g., 3 degrees removed from the primary user) can be hidden and/or restricted from the primary user. This can include censoring the data, modifying the data (e.g., to change sensitive details), and/or any other suitable process. Additionally, or alternatively, the user data (e.g., interactions) associated with a user more than the threshold social proximity distance away from the primary user can be: summarized and displayed to the user, displayed to the user as raw content, and/or otherwise managed.

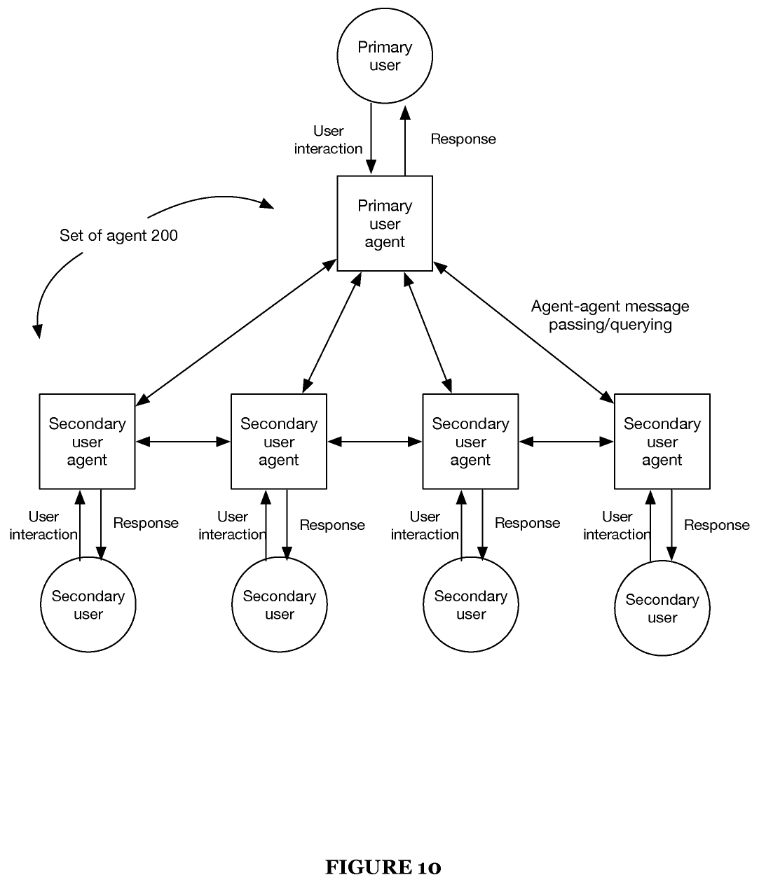

The set of agents 200 can be independent, interconnected, organized as a hierarchy, or otherwise structured. In variants, different agents of the set of agents 200 are configured with different roles, capabilities, and/or objectives (e.g., user interaction, data retrieval, summarization, authorization enforcement, embedding generation, coordination of other agents, and/or any other roles, capabilities, or objectives). The set of agents 200 can issue queries to the database and other agents, retrieve authorized data, write derived data, including notes, summaries, and/or embeddings, back to the database, and/or otherwise interact with the database. The queries can be a user-provided query, one or more secondary queries generated from the user-provided query (e.g., a series of queries predicted to answer the user-provided query), a modified query (e.g., based on system guardrails, etc.), and/or any other query. In some variants, an agent that retrieves a query from a user can query another agent (e.g., to retrieve information), as shown for example in FIG. 10. In some variants, the agents can transform a query (e.g., to produce a privacy-aware request). In variants, transforming the user query can include censoring information, summarizing and/or broadening an information request, adding constraints to the query, and/or any other suitable modifications.

In some variants, tasks are decomposed into subtasks that are assigned to one or more agents based on agent capabilities, availability, and/or role. In some embodiments, an agent can invoke another agent to perform a subtask.

In variants wherein the set of agents 200 generate data for the database, the agent-generated content can be semantic text (e.g., notes, summaries, semantic notes, etc.), latent embeddings (e.g., latent user embeddings), and/or any other suitable data type. In a specific example, the set of agents 200, upon receiving user-generated content (e.g., user interactions, user messages, user logs, user-user interactions, etc.), can generate embeddings, notes, and/or summaries in real-time. For example, the set of agents 200 can generate a continuously updated log of note and/or summaries, documenting user information to be used to generate responses. However, in other variants, the embeddings, notes, and/or summaries can be generated asynchronously from the user interaction, in batches, intermittently, periodically, and/or at any suitable frequency.

In variants, agents can communicate with one another via message passing, shared memory, or indirect coordination through the database. In some variants, the set of agents 200 can adapt over time based on user interactions, feedback, and/or updated models. In some variants, agents can maintain state information across multiple interactions (e.g., enabling continuity of conversations, task tracking, reference to prior interactions, and/or any other interactions). In variants, agents are instantiated dynamically in response to system conditions, user activity, and/or task requirements. In some variants, the set of agents 200 can include agents of different roles and/or hierarchies.

In variants, S400 can operate at a local network level (e.g., within a primary user's immediate social network or local community), a global network level, and or any other level. In variants, this can enable cross-market and cross-network connections. For example, the secondary users can include users or entities outside the primary user's local social network, such as companies, investors, buyers, sellers, or employees in other markets, thereby supporting broader commercial, transactional, and strategic interactions across the global platform. This global network functionality allows S400 to dynamically select secondary users not just based on proximity in a social graph but also based on relevance, market role, or cross-network connectivity, extending beyond conventional social network filtering.

In a variant, the set of agents can operate in continuous autonomous loops, where it ingests new system data, user interactions, secondary user updates, external market signals, and/or any other data, and emits tool calls or actions back into the platform. For example, an agent can detect a trending topic or opportunity within the network, retrieve relevant interaction representations and embeddings, cluster related users or entities, and automatically generate actionable insights or content. These autonomous loops can facilitate both local social-network interactions (e.g., introducing primary users to relevant secondary users or content) and broader market operations (e.g., scheduling meetings, initiating commercial interactions, generating follow-up materials).

In variants, the set of agents 200 can include user agents 210 and an optional central agent 220.

The user agents 210 function to interact with the users and other user agents. In variants, each user of the platform can have (e.g., be associated with, etc.) a user agent. In variants, user agents are configured to interact directly with users (e.g., as a UI / conversational layer), generate responses on behalf of the system, apply behavioral constraints (politeness, tone, safety), apply privacy logic at response time, select, filter, and/or retrieve relevant user-scoped context (e.g., function as a context filter), query the database or other agents, and/or be otherwise configured. The user agents 210 can include instances of a model configured (e.g., modified, context engineered, prompt engineered, etc.) for a specific user of the system. For example, each user agent can utilize a different set of data and/or context, as shown for example in FIG. 11 (e.g., user agent 1 context, user agent 2 context, etc.) In a first variant, a user agent can be context engineered such that a context of the agent includes data associated with a user (e.g., notes and/or summaries associated with user information and/or data, raw interaction data involving the user, and/or any other data). In a second variant, a user agent can be context engineered such that a context of the agent includes data (e.g., notes and/or summaries) associated with a user and a user's first- and second-degree connections (e.g., defined in the social graph). In a third variant, a user agent can be prompt engineered to generate responses according to preferred interaction style, manner, and/or tone.

The user agents 210 can be configured (e.g., prompt engineered, context engineered, etc.) to interact with users. For example, user agents 210 can be configured to generate privacy-aware responses, responses that comply with one or more behavioral constraints (e.g., politeness, contextual sensitivity, avoidance of offensive or inappropriate content, adherence to platform-defined communication standards, etc.), responses that ensure safety, and/or any other suitable standards. In variants, the user agents 210 can be configured (e.g., prompt engineered, context engineered, etc.) to ensure privacy of users. In an example, the user agents 210 can ensure that private information of users (e.g., indicated by a privacy-level meta data) is not shared to non-authorized users. In a first variant, the user agents 210 can ensure only information of a user's first and second connections (e.g., or any other suitable connection degree) are presented to the user. In a second variant, the user agents 210 can ensure that user information (e.g., of the agent's primary user) marked as private and/or any other suitable privacy level is not shown and/or shared to any other users. In a third variant, the user agents 210 can be configured to ask a user to share information prior to sharing the information to another user.

In some variants, the user agents 210 can be configured to predict and/or determine a privacy level (e.g., based on fixed and/or predetermined regulations, user data, user settings, learned policy, known social conventions, user feedback, and/or any other factors). In other variants, privacy level can be user-specified. In variants, the user agents 210 can generate responses, share information, and/or otherwise function based on the privacy levels. The user agents 210 can interact with other agents (e.g., user agents, central agents, etc.), the database, a toolset (e.g., for deterministic processes, stochastic processes, decision trees, etc.), and/or any other system component.

However, the user agents 210 may be otherwise configured.

The set of agents 200 can optionally include a central agent 220, which functions to broadly interact with the platform (e.g., database, user agents, etc.) and coordinate agent behavior and interactions. In variants, the system can include a central agent 220 to facilitate agent interactions and/or perform broad data retrieval and filtering. In some variants, the central agent 220 can perform analyses on data across all users to determine patterns, data similarity, data clustering, and/or any other suitable characterization, which can be used to generate responses.

In a specific example, the central agent 220 can determine similarities between subsets of users, generate cross-user embeddings, and/or generate semantic summaries based on the analyses. These summaries can be passed to user agents and used to generate responses to user queries. The analyses performed by the central agent 220 can enable user agents to suggest user-user interactions based on user similarities, shared interest, and/or compatibility.

In another example, the central agent 220 can perform data retrieval across the database based on a user query. The data can be passed to the user agents to generate a response to the user query (e.g., according to privacy logic, according to behavior constraints, and/or any other constraints).

In variants, the central agent 220 can orchestrate multiple user agents, aggregate data across users, determine summaries and multi-user analysis, perform platform-level reasoning, perform background processes, and/or any other suitable tasks. In some variants, the central agent 220 can coordinate task allocation and/or conflict resolution. For example, the central agent 220 can schedule agent interactions (e.g., agent-agent interactions, agent-user interactions, etc.) according to priority, task urgency, and/or any other constraints.

A system can include one central agent or a plurality of central agents. In variants, the system can include a plurality of central agents, wherein each central agent can be associated with a different set of data of the database (e.g., based on data type, based on users, based on time, etc.). In variants, the central agent 220 can have access to broader database portions than user agents and/or retrieve larger amounts of data as contextual input for generating responses, as shown for example in FIG. 11 (e.g., central agent context). In an example, in a specific variant, the central agent 220 can have access to and/or utilize data from the entire database (e.g., via contextual input, context window, context engineering, etc.), while user agents can have access to a specific user's data (e.g., via context and/or context engineering).

In an example, the set of agents 200 can include user agents 210 and central agents 220. In variants that include central agents and user agents, a user agent can be configured to interact with users while central agents can be configured to interact with the database. In these variants, user agents can ensure that the user receives relevant information, communicate with the user in a predetermined manner, prevent sensitive and/or non-authorized information from being shown to the user, and/or any other suitable task. In this variant, the central agent can be configured to retrieve data from database, perform extensive queries and similarity searches of the database, determine data patterns and/or clusters, and/or any other suitable tasks. The set of agents 200 can include a central agent that can be configured to generate a preliminary and/or initial response to a user query. This initial response can be received by the user agent and modified (e.g., to produce an intermediate or final response) before presenting to the user, be passed through as-is, and/or be otherwise handled. In this example, the initial response can be transformed by the user agent for ensuring accuracy, modifying tone and/or style, ensuring safety (e.g., privacy, security, etc.), and/or for any other suitable function. However, the user agents 210 and central agent 220 can be otherwise configured.

However, the set of agents 200 may be otherwise configured.

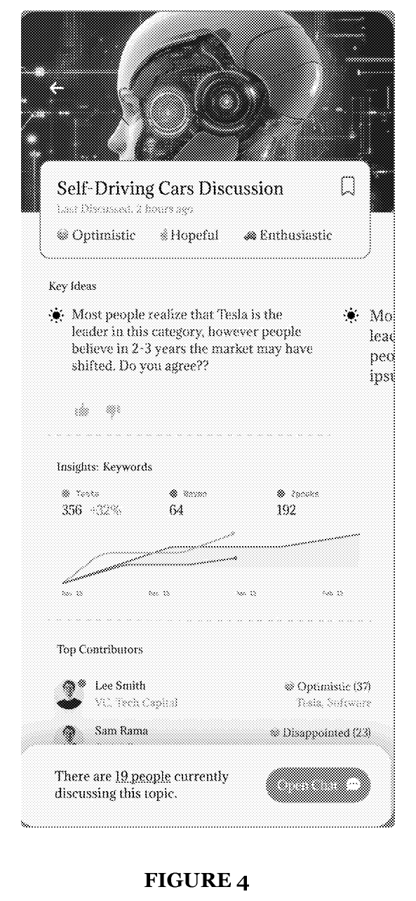

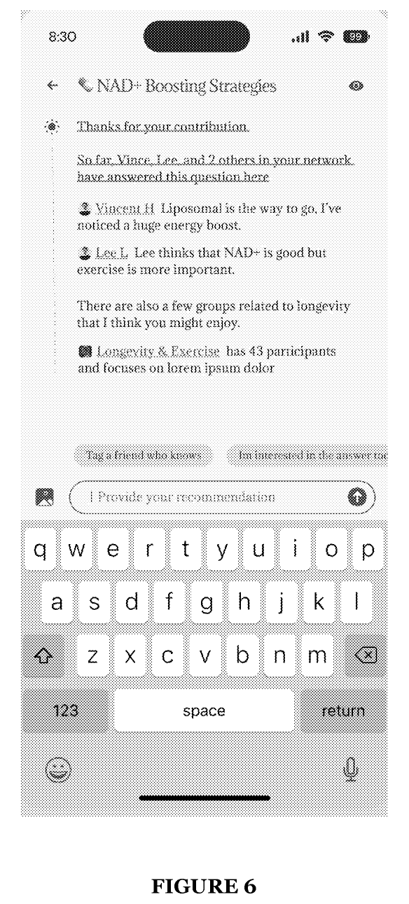

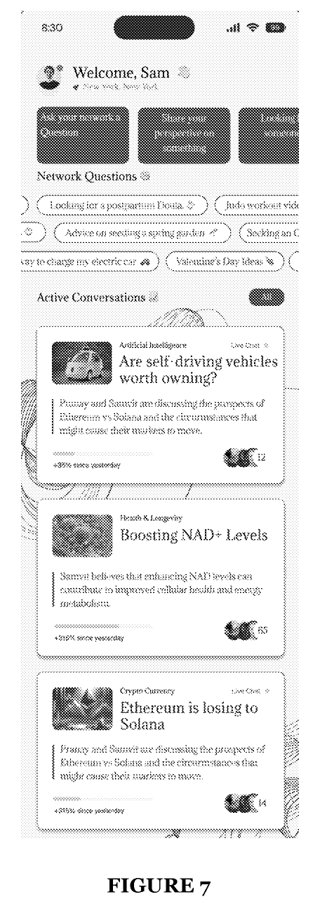

The user interface 300 functions to receive user interactions (e.g., queries, posts, etc.) and/or present platform content (e.g., responses, summaries, feeds, etc.). The user interface 300 can allow the user to interact with a variety of tools and/or perform a variety of tasks. The user interface can include a conversational interface (e.g. chat box, chat room, etc.) with agents (e.g., user agent), a conversational interface (e.g. chat box, chat room, etc.) with other individual users (e.g., 1st degree connections, 2nd degree connections, etc.), a conversational interface (e.g. chat box, chat room, etc.) with groups of users, topic-specific chatrooms, global chatrooms, task trackers, a feed, a data manager, a collective action facilitator, and/or any other user interface components. Groups of users can be generated by agents, user-generated, and/or otherwise determined. Topic-specific chatrooms (e.g., as shown for example in FIG. 6) can be generated by agents, user-generated, and/or otherwise determined. In variants, the global chatroom can include messages from all users of the platform, wherein any user can join and participate, as shown for example in FIG. 4. In some variants, a user's visualization of the global chatroom can be modified such that only messages from users within a threshold social proximity value can be seen. In these variants, the global chatroom can be organized into threads based on user interactions. For example, a conversation within the global chatroom between User A and User B may be tagged to be part of the same thread. Threads can be determined based on rules and/or policies, determined by the set of agents, determined manually, specified by the users, and/or otherwise determined. In a specific example, any thread involving users that exceed a threshold social proximity value can be hidden and/or restricted from a primary user. These threads can be filtered out even if the thread included users within the threshold social proximity range. In another example, conversations from users exceeding a threshold social proximity value can be summarized and presented to the primary user. In this example, the conversations from users within the threshold social proximity range can be summarized along with the other users' conversations, or be presented as raw text. In another example, prior conversations from users (e.g., within the threshold social proximity range, outside of the threshold social proximity range, etc.) can be summarized for new users joining the thread, such that the new users do not need to read the raw transcript. Task trackers can include lists of tasks scheduled by agents (e.g., inquire User A of this information, etc.), completion status, links to associated chat boxes, and/or any other suitable information. In some variants, the user interface includes a feed or dashboard presenting content associated with the user, including summaries, recommendations, chatrooms, conversational interfaces, or updates generated by the set of agents, as shown for example in FIG. 7. The data manager can include an interface for viewing, editing, and/or adding user data. In variants, this can include an interface for adding notes, logs, biographical information, and/or any other suitable information. In variants, privacy settings and/or level of data can be modified in the data manager. The collective action facilitator can start petitions by identifying the (potentially small set of) relevant and interested users across the social network. In variants, the user interface 300 can maintain state information across multiple conversational interfaces (e.g., enabling continuity of conversations, reference to prior interactions, etc.).

However, the user interface 300 may be otherwise configured.

### Method

As shown in FIG. 1, the method can include a determining a social network S100; determining a knowledge database S200; a receiving an interaction associated with a primary user S300; a determining a set of secondary users for the primary user S400; and a generating a response to the interaction based on the set of secondary users and the knowledge database S500. The method functions to provide users with personalized and relevant information. The system can provide users with personalized and relevant information to queries based on their social network. The method can be performed by a platform and/or any other system. The platform can be the platform described above, and/or be any other platform. The platform can include a knowledge database, a set of agents, and/or a user interface that functions to receive user interactions (e.g., queries, posts, etc.) and/or present platform content (e.g., responses, summaries, feeds, etc.). The knowledge database can store user data. The user data can include raw user interactions, interaction summaries (e.g., "notes", “summaries”), embeddings of the interactions, embeddings of the summaries, and/or any other user data. Each piece of user data can be associated with one or more user identifiers (e.g., for the user that generated the user interaction, for users involved in the user interaction, etc.), privacy settings (e.g., public, private, accessible by connections within a predetermined number of degrees, etc.), and/or user interaction metadata (e.g., interaction time, device, topic, etc.). The set of agents can perform one or more of the method processes. The set of agents is preferably the same underlying model architecture with different prompts, context or tuning, but can alternatively be different models. The set of agents can be part of the platform or be provided by a third party system. The set of agents can include a single AI agent, a network of AI agents, multiple individual agents, and/or any number of agents.

The method can be performed when a new query is received, when a new user joins the platform, every time an interaction between the platform and a user is initiated, and/or any other time. All or portions of these processes can be performed iteratively, performed once, repeated, and/or otherwise performed.

Determining a social network S100 functions to represent and maintain relationships between a user and their network within the platform. Determining a social network S100 can be performed during user onboarding, when adding or removing friends, when integrating external data sources (e.g., contact list), and/or at any other suitable times. S100 can be performed periodically, in response to an event or trigger, user-prompted, and/or in any other manner. S100 can be performed by an AI agent, user action (e.g., sending a friend request, etc.), platform, and/or any other performer. The social network can be retrieved from an existing social network and/or external source, retrieved from input by the user, learned from physical proximity, and/or otherwise determined. Each user is associated with a unique user identifier (ex. hash of user information, randomly assigned ID, etc.), but can alternatively be otherwise identified. The social network can be stored using a database (e.g., graph database, vector database, etc.; graphDB, mySQL, etc.), but can alternatively be otherwise stored.

In a first variant, the social network can be retrieved from an existing social network by linking accounts. S100 preferably retrieves first degree connections, but can alternatively retrieve users from additional degrees of connection. In a second variant, the user can manually add other users on the platform to their social network. In a third variant of S100, users can be automatically added and/or connected based on spatial proximity.

In variants, the social network and/or users of the platform can be represented as a social graph (e.g., for determining social connections). In a specific example, the social graph can represent users as nodes and edges as connections. In these variants, a 1st degree connection can be depicted in a graph as a path between 2 users (e.g., nodes) that is one edge long. A 2nd degree connection can be depicted in a graph as a path between 2 users (e.g., nodes) that is 2 edges long. Similarly, a 3rd degree connection can be depicted in a graph as a path between users that is 3 edges long. The social graph can be automatically generated based on determined first degree connections (e.g., from existing social networks, from user definition, from social proximity, etc.). In variants, the social graph can be generated manually, using a model, using a set of rules, and/or otherwise generated. In variants, the social graph can be continuously updated and/or altered based on evolving connections, new users to the platform, and/or any other suitable trigger and/or information. The social graph can be updated based on a trigger (e.g., new user added to platform, and/or any other triggers), periodically, intermittently, sporadically, or at any suitable frequency.

However, the determining a social network S100 may be otherwise configured.

Determining a knowledge database S200 functions to record user interactions, embeddings, notes, summaries, and/or any other suitable information on the platform in structured storage. S200 can be performed when each user interaction is received, after a timeout period of no user interaction (e.g., a user conversation is complete), periodically, event-driven (e.g., every time new content is available), on keyboard press, new content detection, and/or any other triggering events. S200 can be performed independently or in parallel with S100, before S300, before S400, and/or otherwise performed. Determining a knowledge database S200 can be performed by the platform, AI agent, and/or any other system or component. The knowledge database can be determined from user interactions on the platform, user information outside of the platform (e.g., external sources), and/or any other information. The user interactions can include: queries (e.g., questions), posts (e.g., uploaded content, responses to other users in a conversation, etc.), user-generated logs, user-user interactions, messages, and/or any other suitable interaction. The knowledge database can include raw user interactions, model and/or agent generated content, embeddings, and/or any other suitable data. The knowledge database is preferably a vector database, but can alternatively be a graph database, and/or any other suitable database. The knowledge database can store a representation of a user interaction or set thereof. The knowledge database stores embeddings of summaries of interactions, but can alternatively store raw interactions, cleartext summaries of interactions, embeddings of the raw interactions, and/or other representations of the user information. User interaction representations can be generated by an AI agent, an embedding model, a summarization model, and/or any other model. In an example, the user interaction representation can be generated by passing the user information to an AI agent with a prompt (e.g., "summarize these points", and/or any other prompts). Each datum can be stored with metadata for the raw interaction, the representation generation, and/or any other metadata. Examples of metadata that can be stored with the user information representation can include user identifier (e.g., of the authoring user, of users involved in the interaction, etc.), interaction ID, interaction time, interaction location, privacy setting, and/or any other metadata. In variants, the knowledge database can store metadata, tags, identifiers, and/or any other information with each datum.

Each datum can be stored alongside one or more user identifiers (e.g., for the user that generated the user interaction, for users involved in the user interaction, etc.), privacy level and/or settings (e.g., public, private, accessible by connections within a predetermined number of degrees, etc.), user interaction metadata (e.g., interaction time, device, topic, data source, data type, etc.), and/or any other information. The privacy level can be data-specific (e.g., such that each datum has a privacy level, etc.), user-specific (e.g., such that all data associated with a user has a privacy level), topic-specific (e.g., all data associated with a specific topic has a distinct privacy level), and/or be otherwise specified. The privacy level can be user-defined, determined by a model and/or agent, automatically assigned based on policy, and/or otherwise determined. In a specific example, when new data is received by the platform, an agent and/or model can automatically determine and assign a privacy level to the data. The privacy level can be determined by an agent and/or model based on learned policy, a set of rules, based on topic and/or keywords, and/or any other method.

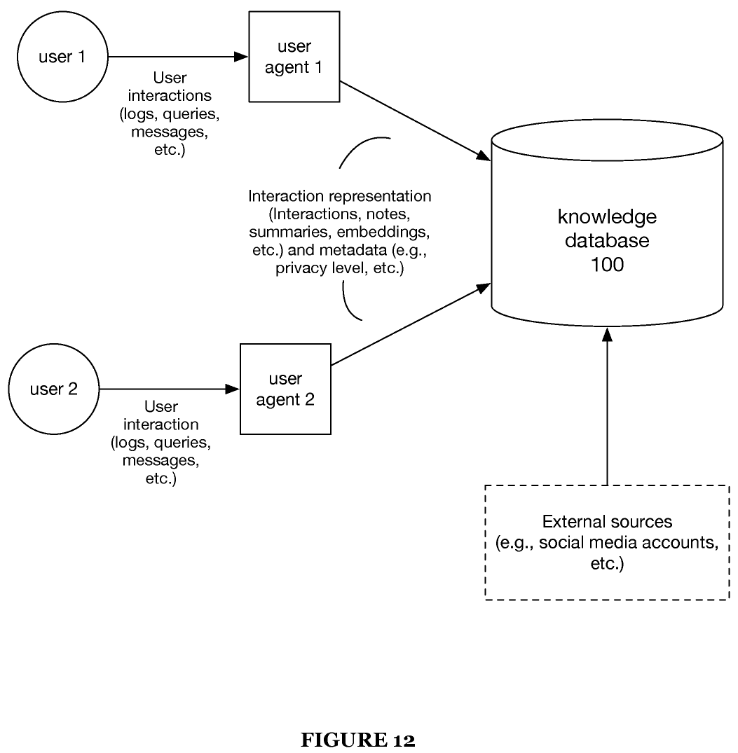

In variants, determining a knowledge database S200 can include retrieving data from external sources (e.g., third-party platforms), as shown for example in FIG. 12. In these variants, the platform can prompt a user for access to external data sources and/or accounts (e.g., to obtain authorized access, via token based authorization protocol, etc.), automatically identify the external data sources (e.g., based on a shared username, etc.), and/or otherwise identify and/or access the external data sources. The platform can prompt the user upon user onboarding, after user onboarding, periodically, and/or at any suitable time. Examples of external sources can include third party social media accounts, websites, calendar and/or scheduling platforms, search engines, contact lists, and/or any other external sources.

The platform can gain access to external source data through an authorization token, access token, and/or any other suitable mechanism. After receiving access and/or permission to the external sources, the platform can retrieve the data automatically, in response to a trigger (e.g., detection of missing data, determination that new data is available on the external data source, etc.), iteratively, or at any suitable frequency. The authorized external data can be transferred from the external source to the platform via secure server-to-server communication (e.g., using one or more application programming interfaces) and/or any other suitable process.

However, determining a knowledge database S200 can be otherwise performed.

Receiving an interaction associated with a primary user S300 functions to generate additional data in the knowledge database, generate content for the user, and/or any other suitable functions. The interaction can be received via a user device (e.g., user typing into a search box and/or chat box, pressing a button), platform interface, and/or any other interface. The primary user can be the authoring user, the owner of the device, and/or any other user. The interactions can be: text-only (e.g., a typed request), image-based (e.g., user uploads an image), audio (e.g., an audio recording, transcribed speech), video, a combination of modalities, and/or have any other modality. In a first example, the user types a query and clicks a "Search" button; the platform receives the raw text, normalizes it, extracts userID from session data, checks access rights, and creates a structured query object. In a second example, the user enters a spoken command, an STT (Speech-to-Text) service converts the spoken command into text; after transcription, the platform normalizes the text, runs keyword extraction, and attaches user context. In a third example, an external application calls the platform's query endpoint with parameters (e.g., JSON POST request), agent validates the API key or OAuth token, checks allowed scopes, normalizes input, and finalizes a structured query. The interaction can be: user interactions with the platform (e.g., interaction with the knowledge database, etc.), user interactions with other users (e.g., one or more secondary users), AI agent interactions with the platform (e.g., the knowledge database), AI agent interactions with other agents (e.g., to retrieve and/or request user information, etc.) and/or include interactions between any other suitable set of entities.

Examples of user interactions can include user messaging and/or querying an agent, user messaging another user, user inputting user-generated logs and/or notes (e.g., in a data manager), user uploading data, and/or any other user interactions. For example, a user can utilize the platform to document personal experiences, ideas, beliefs, and/or opinions.

In variants, the user interactions can be stored into the knowledge database. In a first specific example, the user interaction can include a new conversation with the platform (e.g., querying the platform for information, querying the platform to identify other users with experience in a topic, and/or any other querying). The platform can include an AI agent. The conversation can include journaling. The conversation can be private with one or more users. In a second specific example, the user interaction can include creating a new account, sending a friend request, connecting external accounts, and/or any other interaction. In a third specific example, the user interaction can include uploading content to the platform (e.g., images, external conversations, and/or any other content). The interactions can include metadata (e.g., userID, privacy setting, language codes, etc.), comments, reviews (e.g., book reviews), questions, answers, and/or any other suitable information.

In variants, receiving an interaction associated with a primary user S300 can optionally include generating a representation for the user interaction S320, which functions to represent the summary of the datum as a searchable and retrievable format (e.g., embedding). Generating a representation for the user interaction S320 can be performed automatically, continuously, when new interactions are detected (e.g., new files), when a conversation timeout condition is satisfied, in real-time, asynchronously from the user interaction, and/or otherwise performed. S320 can occur after S100, after S200, during S300, before S400, before S500, and/or at any other time in relation to other steps. Generating a representation for the user interaction S320 can be performed by an AI agent, platform, and/or any other system. In some variants, generating a representation for the user interaction S320 can be performed by an embedding model, summarization model, encoder, and/or any other suitable model and/or module.

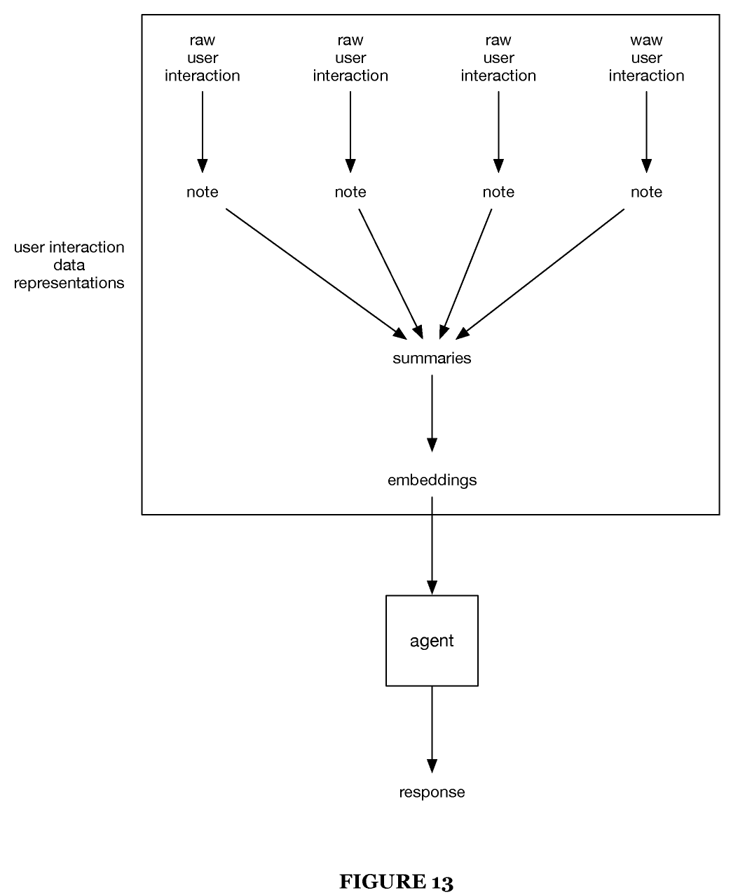

S320 can include generating a note of the user interaction, generating a summary associated with the user interaction, generating an embedding of the user interaction (or note or summary thereof), and/or any other suitable procedure, as shown for example in FIG. 13.

A note of a user interaction can include a summary, a condensation, and/or abstraction of a user interaction or a set of user interactions. The note can be generated by prompting an LLM (e.g., an agent) to summarize the user interaction (e.g., according to a predetermined query, a set of rules or guidelines, etc.), be manually generated, be generated by extracting keywords using a set of keyword extractors, and/or any other suitable procedure. Notes can be generated in-real time (e.g., generated when user interactions are received), asynchronously from the user interactions, periodically (e.g., every N interactions, every N minutes, etc.), intermittently, in batches (e.g., when a predetermined number of interactions are received), and/or at any suitable frequency. In a specific variant, notes can be generated in real-time, such that a log of notes for each user is consistently updated. In some variants, notes can be used as "atomic units of data" for storing, analyzing, and/or otherwise utilizing. The inventors have found that utilizing notes as an atomic data unit (e.g., as opposed to raw user interactions) can result in more accurate and/or precise data analysis, retrieval, pattern recognition, and increases computational efficiency and speed.

A summary can include an aggregation, synopsis, encapsulation, synthesis, and/or other summary of the user interaction and/or notes. For example, in a specific variant, a summary can be an aggregation of notes. The summary can be generated by prompting an LLM (e.g., an agent) to summarize the user interaction (e.g., according to a predetermined query, a set of rules or guidelines, etc.), be manually generated, be generated by extracting keywords using a set of keyword extractors, and/or any other suitable procedure. Summaries can be generated in-real time (e.g., generated when user interactions are received or notes are generated, etc.), asynchronously from the user interactions and/or note generation, periodically, intermittently, in batches (e.g., when a predetermined number of interactions or notes are received), and/or at any suitable frequency. In variants, a user can be associated with a set of summaries. In a first example, each summary can be associated with a specific topic. For example, each summary can be an aggregation of notes and/or user interactions related to similar content. Similarity can be manually determined (e.g., by user, etc.), determined according to rules, determined using an AI agent or model, determined based on features extracted from the summary or raw data, using filters, and/or otherwise determined. In a second example, each summary can be determined based on time. For example, each summary can be an aggregation of notes and/or user interactions from a specific period of time. However, summaries can be otherwise determined. In variants, summaries can be generated, replaced, modified, and/or otherwise updated, based on newly received notes and/or interactions.

S320 can include generating embeddings for user interactions, notes, summaries, and/or any other data representation. The embeddings can be generated from semantic data and/or any other data. The embeddings can be in the keyword space, token space, conceptual space, vector space, and/or any other latent space. The embedding can be generated by the same LLM, by an embedding model (e.g., an encoder), and/or by any other suitable model.

The user interaction representations can include metadata (e.g., authoring user's ID, privacy setting, date of generation, topic, etc.) and/or any other information or be associated with the user interaction's metadata.

However, generating a representation for the user interaction S320 may be otherwise configured.

However, S300 may be otherwise performed.

Determining a set of secondary users for the primary user S400 functions to filter the social network to determine a set of users for generating a query response. S400 can be performed when after S300, after S100, after/in parallel with S200, before S500, and/or at any other time. In variants, the secondary users can define and/or describe a context for data used to generate response to user queries. In an example, data (e.g., interactions, notes, and/or summaries) associated with the set of secondary users and primary users can be used to generate responses to a primary user's query. Secondary users can include users within the primary user's direct social network (N = 1 degree of separation), users within the primary user's extended social network (N = 2 degrees of separation, N = 3 degrees of separation, etc.), users not part of the primary user’s social network (e.g., separated from the primary user by more than a threshold degree of separation), any user of the platform, and/or any other users. Determining a set of secondary users for the primary user S400 can include determining the secondary users associated with a specific degree of separation based on the social graph of users and/or social proximity values. The degrees of separation used to determine the set of secondary users for the primary user S400 can be: predetermined, determined based on the user interaction (e.g., based on the type of user interaction, based on the content of the user interaction, etc.), and/or otherwise determined. For example, the secondary users can include users separated from the primary user by a social proximity of two or less. However, the secondary users can be otherwise determined.

In variants, S400 can operate at a local network level (e.g., within a primary user's immediate social network or local community), a global network level, and or any other level. In variants, this can enable cross-market and cross-network connections. For example, the secondary users can include users or entities outside the primary user's local social network, such as companies, investors, buyers, sellers, or employees in other markets, thereby supporting broader commercial, transactional, and strategic interactions across the global platform. This global network functionality allows S400 to dynamically select secondary users not just based on proximity in a social graph but also based on relevance, market role, or cross-network connectivity, extending beyond conventional social network filtering.

In a first example, the degree of separation used to filter visible content in a globally-accessible chatroom can be different from the degree of separation used to filter which secondary user content is used to answer a primary user's question. In a specific example, a primary user can see content generated by secondary users that are within 3 degrees of separation in a global chatroom, while the platform can use content generated by secondary users within 5 degrees of separation to answer a primary user's query (e.g., "what do people think about the current political climate"). In a second example, the degree of separation for a given interaction context can be dynamically predicted (e.g., by the user agent) based on the context parameters (e.g., topic, privacy, etc.).

The reference user for secondary user set determination can be the primary user or another user (e.g., within the primary user's network, outside of the primary user's network, and/or any other user). In variants, secondary users can include any users associated with a primary user by a social proximity value or degree of separation of 1 or less, 2 or less, 3 or less, 4 or less, 5 or less, and/or any other suitable threshold social proximity value. The secondary set of users can be further filtered based on: user preferences, keywords or attributes (e.g., based on keywords or attributes that are determined to be relevant to the user interaction), time, geography, social group, and/or any other parameters.

In a first variant, determining a set of secondary users for the primary user S400 can start from the primary user and include identifying all users connected within a specified degree of separation (e.g., N = 2 or N = 3). In a first example of the first variant, determining a set of secondary users can include performing a breadth first search to explore connections level by level, retrieving all users at each degree of separation simultaneously. In a second example of the first variant, determining a set of secondary users for the primary user S400 can include performing a depth first search to explore each path (e.g., of a social graph) from the primary user, retrieving users within each degree of separation sequentially.

In a second variant, the set of secondary users can include users whose privacy settings allow public visibility. In a first example of the second variant, determining a set of secondary users for the primary user S400 can include applying a privacy filter to the entire social graph, removing nodes that the primary user cannot access, and then use BFS or DFS to retrieve users within N degrees of separation.

In a third variant, determining a set of secondary users for the primary user S400 can include traversal through a social graph, where the traversal begins with a specified user within the primary user's network for targeted searches. In a first example of the third variant, determining a set of secondary users for the primary user S400 can include identifying a user with "XYZ experience" and exploring their connections to find relevant users.

In a fourth variant, determining a set of secondary users for the primary user S400 can include manually selecting secondary users by the primary user. In an example, a primary user can select a set of users whose data can be used to generate a response to the interaction.

In variants, the set of secondary users can be determined from factors and/or metrics other than social proximity value, such as similarities between users and/or any other metric. Similarities can include shared attributes, shared interests, shared professional experiences, shared demographic attributes, shared activity patterns, shared behavioral signals, shared user interaction history, shared engagement with similar content, semantic similarity between user-generated content, embedding similarity between user profiles, and/or any other similarity metric. In variants, similarity can be determined based on structured data (e.g., user profile fields, tags, user declared interests), unstructured data (e.g., posts, messages, notes), learned representations (e.g., user embeddings generated by a machine learning model), and/or any combination thereof. In a first example, determining the set of secondary users can include identifying users whose associated interactions and/or interaction embeddings are within a similarity threshold of the primary user's embedding. In a second example, determining the set of secondary users can include identifying users who have interacted with similar content or participated in similar discussions (e.g., in a chat room). However, secondary users can be otherwise determined.

In variants, similarity-based determination can extend beyond the primary user's social network to include users outside of the primary user's direct or extended network, including users within a global user pool. In variants, the set of secondary users can be determined using a matchmaking model configured to predict relevance, compatibility, expertise, affinity, or response quality with respect to a given interaction context. The matchmaking model can use social graph features, content features, behavioral features, historical interaction data, and/or contextual parameters associated with the interaction to determine the set of secondary users. For example, S400 can include performing a search or clustering algorithm through latent feature embedding space of user interactions can be performed to determine users who engage in similar user interactions. In some implementations, embeddings derived from profiles and associated knowledge base notes can be clustered in a bottom-up manner to dynamically define markets, subcategories, or thematic domains. This clustering can reveal emergent market structures (e.g., geographically bounded professional ecosystems, industry-specific networks, or topical communities) without requiring predefined taxonomies.

In an example, the set of secondary users can be determined based on similarity metrics in addition to or instead of social proximity. Users can be represented as vectors within a latent feature embedding space derived from user profiles, user-generated content, interaction history, behavioral signals, and/or activity data. A search through the latent feature embedding space can be performed to identify users exhibiting similar interactions, interests, expertise, or engagement patterns. Similarity can be computed using cosine similarity, Euclidean distance, dot product similarity, learned similarity functions, and/or other distance metrics. Nearest-neighbor search (e.g., exact or approximate) can be used to retrieve candidate secondary users whose embeddings satisfy a similarity threshold relative to an embedding associated with the primary user and/or the interaction context. In variants, this embedding space can be structured into hierarchical clusters representing markets and sub-markets, enabling retrieval constrained to a dynamically inferred market segment (e.g., a regional professional market or industry-specific cluster).

In another example, clustering techniques can be used to group users based on embedding similarity and/or graph structure. The set of secondary users can include users within the same cluster, users within clusters associated with a relevant topic, and/or users predicted to be compatible with the primary user. In some implementations, similarity-based retrieval can extend beyond the primary user’s social network to a global user pool, and candidate users can be filtered or ranked based on social proximity, privacy settings, historical engagement quality, recency, and/or contextual parameters associated with the interaction. Clustering can further enable analysis of transaction patterns, connection density, influence metrics, and cross-cluster interactions to form structured views of key actors and relationships within a defined market. In variants, embedding matching, hierarchical clustering, market structuring, cluster-level summarization, and or any other processes, can be used to filter data prior to language-model processing, thereby enabling scalable matchmaking and response generation.

In variants, determining the set of secondary users for the primary user S400 can include detecting when a current set of users (e.g., a primary user’s 1^{st} and 2^{nd} connections, etc.) does not satisfy a user request (e.g., unmet demand) and automatically initiating a secondary-user search. An unmet demand can occur when a primary user interaction (e.g., a query, request, etc.) specifies criteria (e.g., expertise, interest, experience, location, industry, role, etc.) that cannot be satisfied by users within an initially determined subset (e.g., the primary user’s local network or users within a specified degree of separation). The unmet demand can be represented by keywords, structured attributes, and/or a vector representation derived from the interaction.

In variants, the system can assign a score or metric to the unmet demand representing confidence that additional secondary users should be identified. The score can be determined based on the user query, interaction data associated with the primary user, and/or data associated with currently available secondary users. The score can be determined using rules, heuristics, models, or learned policies. Explicit requests for new connections can be assigned higher scores than inferred unmet demands. When multiple unmet demands are present, scores can be aggregated. The score can dictate whether a search is initiated and/or the breadth or depth of the search. However, the score can be otherwise determined and/or utilized.

In variants, the unmet demand can be encoded into an embedding and compared against embeddings associated with candidate secondary users (e.g., profile embeddings, interaction embeddings, expertise embeddings). When fewer than a threshold number of users exceed a similarity threshold, the system can automatically trigger a secondary-user search. Prior to initiating a new discovery process, the system can compare the unmet demand embedding with embeddings of other active unmet demands and, when similarity exceeds a threshold, associate the demand with an existing search rather than creating a duplicate process.

The secondary-user search can include searching through a social graph, a user embedding space, and/or other user data structures. The search can include similarity-based retrieval, nearest-neighbor search, graph traversal (e.g., breadth-first or depth-first), and/or hybrid approaches. Retrieved users can be filtered or ranked based on similarity to the unmet demand, social proximity, privacy constraints, activity level, and/or other relevance metrics. In variants, the retrieved users can be validated based on the user’s profile, interaction data, and/or any other suitable data.

In some variants, the discovery process can include generating multiple alternative filtering configurations and/or search methods. Each configuration and/or search method can prioritize different attributes (e.g., industry similarity, job title similarity, geographic proximity, behavioral similarity, or engagement patterns). The system can evaluate each configuration based on a relevance metric (e.g., proportion of retrieved users satisfying a similarity threshold). When a configuration produces low-relevance results, the system can modify or replace the configuration and continue searching. The process can iterate until a sufficient number of relevant secondary users are identified or until predefined efficiency limits are reached.

In some variants, determining a secondary user can include determining a match score and/or confidence score between the primary user and the candidate secondary user using one of a plurality of matching algorithms. The system can dynamically select which matching algorithm to apply based on properties of the underlying need (e.g., presence of geographic constraints, user classification, unmet demand classification, or other contextual attributes). In variants, each matching algorithm can compute a base similarity score (e.g., embedding similarity between an unmet demand representation and a candidate user representation) and apply a bidirectional motivation adjustment factor that increases the score when both the primary user and candidate secondary user exhibit high motivation levels. The motivation level and/or value of a user can be based on user interactions, based on time interacting with the platform, user-defined, and/or otherwise determined. The bidirectional motivation factor can be determined using a geometric mean of respective motivation values such that the score increases meaningfully only when both parties demonstrate interest.

In a first variant, an embedding-based algorithm can determine the match score based primarily on embedding similarity and the bidirectional motivation factor. In a second variant, a geography-aware algorithm can incorporate geographic proximity as either a weighted boost or a required constraint prior to scoring. In a third variant, a category-aware algorithm can adjust the match score based on compatibility between respective need categories using a predefined compatibility matrix. In a fourth variant, a market-aware algorithm can adjust the match score based on shared membership within a hierarchical market taxonomy (e.g., same cluster, subcategory, or category). The system can retrieve an expanded set of candidate users (e.g., using an overfetch multiplier) prior to final ranking to preserve recall when applying filtering or boosting constraints. The resulting candidate secondary users can be ranked based on the computed match score and provided for connection, notification, or automated interaction facilitation.

When a candidate secondary user is determined, in a first variant, the candidate secondary user can be automatically added to the primary user connections. In a second variant, the candidate secondary user and/or primary user can be notified of the potential connection. In a third variant, a suggested user interaction can be determined (e.g., using a model) and presented to the primary user. However, any suitable steps can be performed when a secondary user is determined.

However, the determining a set of secondary users for the primary user S400 may be otherwise configured.

Generating a response to the interaction based on the set of secondary users and the knowledge database S500 functions to identify a set of relevant user interactions associated with the set of secondary users and synthesize a response based on the set of relevant user interactions and the primary user's interaction. S500 can be performed by: a set of agents 200, an AI agent/LLM (e.g., GPT-4, PaLM, custom LLM), and/or any other suitable system or component. S500 is preferably performed by the user agent, but can additionally or alternatively be performed by the other users' agents, a central agent, another agent, and/or other module. S500 can be performed after S300, after S400, after S100, after S200, and/or after any other step. In variants, steps S300 to S500 can be performed by the agents in a continuous loop. The response can include information from a single summary, information from multiple relevant summaries, (e.g., summarizing, consolidating, elaborating on key points from different summaries) links, references, and/or metadata (e.g., timestamps, authors). In variants, responses can be generated based on user interactions, notes, summaries, embeddings, and/or any other suitable data. In variants, responses can be generated based on data associated with primary and/or secondary users, data retrieved from external sources (e.g., the Internet), and/or any other suitable data. In a specific example, generating a response to the interaction based on the set of secondary users and the knowledge database S500 can include generating responses based on summaries and/or notes associated with the primary user and secondary users. The inventors have found that utilizing summaries and/or notes rather than raw interaction data can result in more accurate responses and faster computation.

In a first variant, S500 can include retrieving user interaction representations associated with the set of secondary users S520, optionally querying other agents (e.g., other user agents, secondary agents, central agent, etc.) for user interaction representations S540, optionally filtering the retrieved user interaction representations (e.g., using the primary user's interaction) S560, and/or prompting the AI agent to generate a response based on the retrieved user interaction representations and optionally the primary user's interaction S580.

Retrieving user interaction representations associated with the set of secondary users S520 can include retrieving data from the knowledge databases based on user identifiers, degrees of separation from a primary user, keywords, tags, similarity searches, privacy level, and/or any other suitable method.

Optionally querying other agents (e.g., other user agents, secondary agents, central agent, etc.) for user interaction representations S540 can include a primary agent querying agents associated with the secondary users to retrieve information (e.g., information and/or data in the context window of the other agents, etc.). Querying other agents can include passing a primary user's interaction and/or query to another agent (e.g., direct message passing), transforming a primary user's interaction and/or query and passing the transformed interaction to the other agent, and/or any other way of querying other agents. In variants, a model and/or agent can transform a user interaction according to privacy rules, safety rules, behavioral constraints, learned policy, and/or any other suitable constraints. For example, a user interaction and/or query can be transformed into a privacy-aware request for data. Determining a transformed interaction can include censoring the interaction, broadening and/or summarizing the interaction, adding constraints and/or conditionals to the interaction, and/or any other way of determining a transformed interaction.

The primary agent can query agents associated with the set of secondary users (e.g., user agents 210), a central agent 220, and/or any other suitable agents. Querying a user agent can restrict the retrieved user interaction representations to those that are part of the queried user agent's context window, while querying a central agent queries a larger context window. In variants, the primary agent can query a global agent to get an initial response. The primary agent can present a final response determined based on the initial response to the primary user. The primary agent can modify and/or transform the initial response based on privacy rules, behavioral constraints, learned policy, and/or any other suitable modifications. However, querying user agents, central agents, and/or other agents can otherwise function. The agent that receives a query can generate an initial response, query another agent, query an associated user, and/or otherwise function.

In a first example, a queried agent can generate a response to the agent query. A primary user agent can query a secondary user agent about a secondary user's opinion. The secondary user's agent can generate a response that is sent to the primary agent. This response can be used by the primary agent to generate a final response to be presented to the primary user, and/or passed through as-is.

In a second example, after a primary agent queries a first agent (e.g., an agent of a user connected to the primary user through a first degree connection, etc.), the first agent can query a second agent (e.g., an agent of a user connected to the primary user through a second degree connection, etc.). The primary agent can then receive data (e.g., user interaction representations) from the second agent. However, in other variants, the primary agent can directly query a second-degree connection's user agent.

In a third example, after a secondary user agent receives a query from a primary agent, the secondary user agent can prompt the secondary user to answer. For example, the secondary user agent can ask the secondary user if it can share data (e.g., a user interaction representation) to the primary user and/or primary agent.

However, S540 can be otherwise performed.

Optionally filtering the retrieved user interaction representations (e.g., using the primary user's interaction) S560 can reduce the amount of context passed to the AI agent in S580 and/or can filter for relevant user interaction representations, privacy, and/or any other suitable filtering. Relevant user interaction representations can be determined by computing distance metric (e.g., cosine similarity, Euclidean Distance, dot product, etc.) between the respective user interaction representation and the primary user interaction (or derivative information therefor, such as keywords, queries, etc.), clustering methods (e.g., centroid clustering, k-means clustering, etc.), nearest neighbor traversal, and/or any other similarity search methods.

In an example, S560 can include receiving an embedded query vector (using the embedding model from S200), performing an ANN search to find semantically similar summaries, and returning top-N closest results based on cosine similarity and/or any other distance metric.

Interaction embeddings can be grouped into clusters based on vector similarity and relevant interactions can be identified by comparing an embedding of a primary interaction to one or more cluster centroids. Interaction embeddings can be filtered based on a similarity threshold, such that relevant interactions are identified by determining which interaction embeddings exceed a predefined similarity score relative to an embedding of a primary interaction. Interaction embeddings can be organized into a similarity graph, and relevant interactions can be identified by traversing one or more neighboring nodes associated with an embedding of a primary interaction. User interaction representations can be filtered based on privacy levels. For example, each user interaction representation can be associated with a privacy level (e.g., user-designated, determined from agent, etc.). In variants, user interaction representations with a threshold privacy level can be filtered out.

Relevant user interaction representations can be limited to content that the user has access to. In a first example, the relevant user interaction representations can be limited to content authored by the user. In a second example, the relevant user interactions representations can be limited to public content authored by connected users (e.g., within a predetermined degree of separation, wherein the predetermined degree of separation can be 2 degrees, 3 degrees, 4 degrees, and/or any other degrees). For example, the relevant user interaction representations can be limited to only content authored by connected users. In a third example, the relevant user interaction representations can be limited to private content authored by connected users in a conversation that the user was part of. In a fourth example, the relevant user interaction representations can be limited to private content authored by connected users that the user has been granted access to. In a fifth example, the relevant user interaction representations can be limited to private content authored by connected users that the user does not have direct access to (e.g., wherein the private content can be used to provide population-level summaries for the user or used to identify the connected user, but is not presented to the user). In a sixth example, the relevant user interaction representations can include all public content.

However, S560 can be otherwise performed.

Prompting the AI agent to generate a response based on the retrieved user interaction representations and optionally the primary user's interaction S580 can function to generate a response by prompting an AI agent (e.g., set of agents 200) to answer a query using the user interaction representations (e.g., embeddings of the summaries) associated with the set of secondary users. The AI agent can include an instance of a large language model (LLM), and/or each agent can be an instance of a neural network, convolutional neural network, graph neural network, machine learning model, and/or any other suitable model. The model input can include user interaction from S300 (e.g., preferably can be embedding of query, can optionally be raw query, etc.), context (e.g., user data, metadata, social network, behavioral constraints and/or settings), the set of retrieved and validated summaries and/or notes (from S560), query set (e.g., "generate a response"), explicit formatting instructions or output schema, inference parameters (e.g., setting temperature of LLM), and/or any other input. The query set can be generated based on the primary user interaction and/or otherwise determined. The query set can be looked up based on the primary user interaction type (e.g., determined by classifying the user interaction; determined based on the user interface that received the user interaction; etc.), generated by an AI agent (e.g., by passing the user interaction to the AI agent and prompting the AI agent to generate a series of queries or prompts), and/or otherwise determined. The query set can include one or more queries.

The model output is preferably a structured or formatted response (e.g., text-based, multimodal = text plus image thumbnails or attached documents, etc.). Examples of the output can include a text-based response to a query, generated content (e.g., infograph, podcast, etc.), an action (e.g., performing a task, messaging another user, scheduling a calendar event, creating a chatroom, etc.), and/or any other output. The output can be a synthesized response based on the secondary users' interaction representations, the secondary users' interaction representations, an identifier or attribute of one or more secondary users (e.g., when the primary user is asking for secondary users with expertise in a topic), and/or any other output. The output can optionally include confidence threshold, and/or other inference information. The agent can be configured to generate responses that follow privacy rules and/or regulation, behavioral constraints, safety rules, and/or any other suitable constraints.

In a first example, generating a response to the interaction can include generating a response that prevents (e.g., restrict, hide, censor, obfuscate, and/or any other) specific information from being seen by the user. For example, the model can restrict information associated with un-connected users (e.g., users that exceed a threshold social proximity value), information associated with a specific privacy level, and/or any other information. Restriction, censorship, and/or obfuscation can be enabled through data retrieval and/or filtering (e.g., in S540) or by the agent (e.g., through learned policy and/or rules, and/or any other). In a second example, the agent can generate responses that present a predetermined tone and/or manner (e.g., politeness, playfulness, and/or any other manner). In a third example, the agent can generate responses that follow a set of programmed rules and guard rails associated with safety.

In a first variant, generating a response can include: retrieving user interaction representations associated with the set of secondary users and presenting the retrieved user interaction representations to the primary user. In a second variant, S500 can include filtering a global set of user interactions to those generated by the set of secondary users for display.

However, S580 and S500 can be otherwise performed.

The following examples illustrate representative use cases of the method and are provided for illustrative purposes only. These examples are not intended to be exhaustive and should not be construed as limiting the scope of the invention.

In a first example, the platform enables the user to take private notes and/or journal (e.g., "remember this for me", "explore past notes", etc.). In this example, the agent filters retrieved data to include only user-authored content (and/or summaries thereof), and optionally generates a condensed summary of the user's personal summaries.

In a second example, the platform enables the user to participate in public group chats with a personalized filter wherein the user is shown content from public group conversations generated by users within their social network (e.g., generated by users within N degrees of separation, such as 1 degree, 2 degrees, 3 degrees, a user-specified number of degrees, a dynamically-determined number of degrees based on the amount of returned content, etc.).

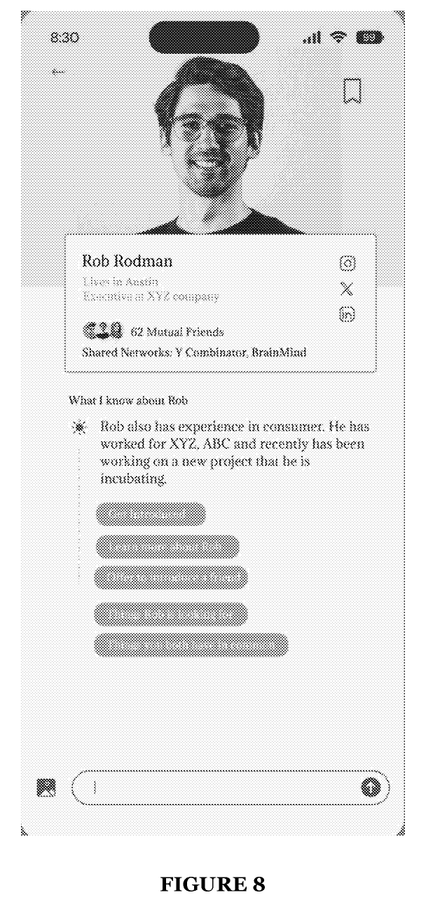

In a third example, the platform enables the user to connect with other users within the primary user's extended social network. In this example, the user asks the platform for users associated with a query (e.g., experts in a field, users with experience with a topic, and/or any other topic). The agent filters content from the knowledge database to those originating from connected users within N degrees of separation (e.g., 2-3 degrees) in the social graph, determines a relevancy score for each connected user based on the user's query and the connected users' respective content, and returns users with the highest relevancy score. The relevancy score can be determined based on embedding distance between the query and a piece of content associated with the connected user (e.g., users with close individual pieces of content have high relevancy scores), embedding distance between the query and the average or median embedding of the connected users' content, keyword matching between the query and the content (e.g., high percentage matches can have high relevancy scores), and/or any other basis for determining relevancy score. In variants, the platform can automatically generate a chat room and/or conversational interface between users. In some variants, the agent can introduce the users and/or prompt conversation, as shown for example in FIG. 8.

In a fourth example, the platform enables the user to query their social network wherein the user can query against content from their social network (e.g., query their network for advice or resources). In this example, the agent filters content to those originating from users within N degrees of separation (e.g., 2-3 degrees of separation), identifies content generated by the set of filtered users that is relevant to the query (e.g., based on an embedding distance, and/or any other distance), optionally ranks the filtered content (e.g., based on embedding distance, relevancy, user preferences, authoring user's social network proximity to the user, and/or any other ranking criteria), and generates a response based on the filtered content. The response can be generated by: providing the query and the content (e.g., raw information, summaries thereof, or embeddings thereof) to a response model (e.g., large model, transformer, GPT, etc.) and prompting the response model to generate a response to the query; querying against the filtered content using a summarization model (e.g., BERT, BART, extractive summarization models, etc.); and/or any other suitable methods. Additionally or alternatively, when the knowledge database contains insufficient user interaction representations to answer the query and/or the AI agent is not sufficiently trained to answer the question (e.g., the resultant AI agent result has a confidence score below a threshold), the platform (e.g., AI agent or the platform itself) can return a set of secondary users that may be able to answer the query, and offer to connect the primary user to one or more of the secondary users. The primary user can query against the user interaction representations for a selected secondary user (e.g., wherein the query and user interaction representations can be sent to an AI agent for response generation), interact directly with the secondary user (e.g., wherein the AI agent can organize the interaction by coordinating with both parties, querying their respective calendars, complying with their respective communication preferences, and/or any other processes), and/or otherwise interact with the secondary user.

In a fifth example, the platform generates content related to a user's social network. The platform can create podcasts, articles, infographs, newsletters and/or any other suitable content related to the user's social network. The content can inform a user on their social network's recent experiences, the opinions and/or ideas of their social network, and/or any other suitable information. In this example, the platform can automatically generate content, generate content based on a user request, and/or generate content based on a trigger (e.g., detection of a specific user interaction topic). In variants in which content is automatically generated, the platform can generate content periodically, intermittently, sporadically, or at any suitable frequency. In these variants, the platform can retrieve interaction representations based on a filter and/or prioritization, use the retrieved interaction representations as context in a generative machine learning model and/or agent, and/or otherwise operate. For example, interaction representation can be retrieved based on topic (e.g., representations that mention keywords), time (e.g., representations generated within the past week, etc.), users (e.g., representations associated with a predetermined set of users), priority (e.g., representations associated with high priority and/or high interest topics), and/or any other suitable property.

In a sixth example, generating a response to the interaction based on the set of secondary users and the knowledge database can plan a meeting and/or social event. In an example, an agent can create calendar events, invite users, and create chatrooms associated with a meeting and/or social event. In some variants, the agents can search user calendars to determine a time and/or location for a scheduled social event.

In a seventh example, S500 can further support AI-driven sales and market execution, where the agents not only generates responses but also autonomously performs tasks associated with research, lead identification, content generation (e.g., pitch materials, newsletters, infographs), and transaction facilitation. For example, the agent can analyze user interactions, summaries, and embeddings to identify opportunities for engagement with secondary users who are relevant to a commercial or professional context. This functionality enables the agent to proactively recommend contacts, propose meetings, or initiate transactions based on patterns detected in the knowledge database and global network connections. The agents can autonomously manage and facilitate both business transactions and local social-network interactions, effectively participating in market operations.

In an eighth example, the platform provides real-time guidance during a live interaction (e.g., a phone call, video call, interview, negotiation, support session, or other conversation). The platform can receive streaming transcript data associated with the primary user and maintain a sliding window of recent finalized transcript segments, preserving speaker attribution. The transcript window can be combined with contextual data from the knowledge database (e.g., contact background, prior interactions, relevant summaries) and provided to a user agent to generate contextual guidance in real time. The system can detect and correct transcript inconsistencies (e.g., premature segment finalization) to maintain an accurate conversational state representation. Before generating new guidance, the platform can evaluate whether previously generated guidance remains applicable to the current conversation state. When the conversation context has not materially changed, the system can reuse prior guidance and extend its association to the current transcript state rather than generating redundant content. When the conversation context has materially shifted, the system can generate updated guidance using streaming model output. Generated guidance can be batched and published to connected clients at defined intervals to reduce communication overhead while maintaining real-time responsiveness.

In a ninth example, the platform processes inbound communications (e.g., emails) by first classifying each message into types such as direct request, clarification, interest, decline, or delay notice, using a model. Based on the classification, the system routes the message through a decision tree: a pass path for messages requiring no action, a defer path that schedules future response (e.g., user-generated, model-generated, etc.), an escalation path that routes the message to the user, or a reply path that generates a contextual response using knowledge database content and/or inventory matches. In variants, responses can reference matches with specificity proportional to confidence scores, and scheduling updates (e.g., creating, modifying, or canceling calendar events) can be performed automatically.

However, generating a response to the interaction based on the set of secondary users and the knowledge database S500 may be otherwise configured.

### Specific Examples

Specific Example 1. A system comprising: a knowledge database comprising a set of summaries generated by a set of agents from a set of raw data provided by a plurality of users, wherein the plurality of users is organized in a social graph; and the set of agents, comprising a primary agent associated with a primary user, wherein the primary agent: receives a user query from the primary user, wherein the primary user is associated with a set of secondary users determined based on the social graph; queries a set of secondary agents associated with the set of secondary users based on the user query; receives, from the set of secondary agents, a set of data representations generated from secondary summaries of the set of summaries associated with the set of secondary users, wherein the set of data representations is not generated from the set of raw data; and generates a response to the user query based on the set of data representations.

Specific Example 2. The system of Specific Example 1, wherein the set of secondary users consists of users of the plurality of users separated from the primary user on the social graph by a social proximity value of two or less.

Specific Example 3. The system of Specific Example 1, wherein the set of agents further comprise a central agent that generates an initial response to the query based on the set of data representations, wherein the primary agent receives the initial response from the central agent and refines the initial response to generate the response to the user query.

Specific Example 4. The system of Specific Example 1, wherein the primary agent transforms the user query into a privacy-aware request and queries the set of secondary agents based on the privacy-aware request.

Specific Example 5. The system of Specific Example 1, wherein each data representation of the set of data representations is associated with a privacy level, wherein the set of agents filters the set of data representations based on the privacy level to determine a filtered set of data representations, wherein the primary agent generates the response to the user query based on the filtered set of data representations.

Specific Example 6. The system of Specific Example 5, wherein the set of agents automatically determine a privacy level for each data representation.

Specific Example 7. The system of Specific Example 1, wherein the primary agent is configured to restrict data representations from being viewed by the primary user based on the social proximity value.

Specific Example 8. The system of Specific Example 1, wherein the set of summaries associated with the set of secondary users is generated by the set of secondary agents, wherein the set of data representations comprises a set of latent embeddings, wherein the set of latent embeddings is generated based on the set of summaries.

Specific Example 9. The system of Specific Example 8, wherein the set of secondary agents filters a plurality of data representations in latent feature space to generate the set of data representations prior to transmitting the set of data representations to the primary agent.

Specific Example 10. The system of Specific Example 1, wherein each agent of the set of agents comprises an instance of a large language model.

Specific Example 11. The system of Specific Example 1, wherein the knowledge database comprises data automatically retrieved from external sources, wherein the data from the external sources is used to generate the set of summaries.

Specific Example 12. A method comprising: at a primary user agent: receiving a user query from a primary user, wherein the primary user is associated with a set of secondary users, wherein the set of secondary users consist of users of the plurality of users separated from the primary user on a social graph by a social proximity value of two or less; querying a set of secondary agents associated with the set of secondary users based on the user query; receiving a set of data associated with the set of secondary users from the set of secondary agents; and generating a response to the user query based on the set of data.

Specific Example 13. The method of Specific Example 12, wherein the set of data is generated by the set of secondary agents using a set of summaries, wherein the set of summaries are generated by the set of secondary agents based on a set of raw input received from the set of secondary users, wherein the set of data is not generated from the raw input.

Specific Example 14. The method of Specific Example 13, wherein the raw input comprises a set of user-generated logs.

Specific Example 15. The method of Specific Example 13, wherein the set of summaries are generated by the set of secondary agents in real-time.

Specific Example 16. The method of Specific Example 12, further comprising, at the primary user agent, transforming the user query into a privacy-aware request and querying the set of secondary agents based on the privacy-aware request.

Specific Example 17. The method of Specific Example 12, further comprising: at a central agent, generating an initial response to the query; and at the primary user agent, refining the initial response to generate the response to the user query.

Specific Example 18. The method of Specific Example 12, wherein each datum of the set of data is associated with a datum-specific privacy level predicted by the set of secondary agents, wherein the set of data is determined by the set of secondary agents based on the datum-specific privacy level.

Specific Example 19. The method of Specific Example 12, wherein the primary user agent restricts data from being viewed by the primary user based on the social proximity value.

Specific Example 20. The method of Specific Example 12, wherein the set of secondary agents determines the set of data, wherein determining the set of data comprises filtering a database comprising data associated with the primary user and secondary users in latent feature space.

Optional elements, which can be included in some variants but not others, are indicated in broken lines in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system comprising:
a knowledge database comprising a set of summaries generated by a set of agents from a set of raw data provided by a plurality of users, wherein the plurality of users is organized in a social graph;
the set of agents, comprising a primary agent associated with a primary user, wherein the primary agent:
receives a user query from the primary user, wherein the primary user is associated with a set of secondary users determined based on the social graph;
queries a set of secondary agents associated with the set of secondary users based on the user query;
receives, from the set of secondary agents, a set of data representations generated from secondary summaries of the set of summaries associated with the set of secondary users, wherein the set of data representations is not generated from the set of raw data; and
generates a response to the user query based on the set of data representations.

2. The system of claim 1, wherein the set of secondary users consists of users of the plurality of users separated from the primary user on the social graph by a social proximity value of two or less.

3. The system of claim 1, wherein the set of agents further comprise a central agent that generates an initial response to the query based on the set of data representations, wherein the primary agent receives the initial response from the central agent and refines the initial response to generate the response to the user query.

4. The system of claim 1, wherein the primary agent transforms the user query into a privacy-aware request and queries the set of secondary agents based on the privacy-aware request.

5. The system of claim 1, wherein each data representation of the set of data representations is associated with a privacy level, wherein the set of agents filters the set of data representations based on the privacy level to determine a filtered set of data representations, wherein the primary agent generates the response to the user query based on the filtered set of data representations.

6. The system of claim 5, wherein the set of agents automatically determine a privacy level for each data representation.

7. The system of claim 1, wherein the primary agent is configured to restrict data representations from being viewed by the primary user based on the social proximity value.

8. The system of claim 1, wherein the set of summaries associated with the set of secondary users is generated by the set of secondary agents, wherein the set of data representations comprises a set of latent embeddings, wherein the set of latent embeddings is generated based on the set of summaries.

9. The system of claim 8, wherein the set of secondary agents filters a plurality of data representations in latent feature space to generate the set of data representations prior to transmitting the set of data representations to the primary agent.

10. The system of claim 1, wherein each agent of the set of agents comprises an instance of a large language model.

11. The system of claim 1, wherein the knowledge database comprises data automatically retrieved from external sources, wherein the data from the external sources is used to generate the set of summaries.

12. A method comprising:
at a primary user agent:
receiving a user query from a primary user, wherein the set of secondary users consist of users of the plurality of users separated from the primary user on a social graph by a social proximity value of two or less; querying a set of secondary agents associated with the set of secondary users based on the user query;
receiving a set of data associated with the set of secondary users from the set of secondary agents; and
generating a response to the user query based on the set of data.

13. The method of claim 12, wherein the set of data is generated by the set of secondary agents using a set of summaries, wherein the set of summaries are generated by the set of secondary agents based on a set of raw input received from the set of secondary users, wherein the set of data is not generated from the raw input.

14. The method of claim 13, wherein the raw input comprises a set of user-generated logs.

15. The method of claim 13, wherein the set of summaries are generated by the set of secondary agents in real-time.

16. The method of claim 12, further comprising, at the primary user agent, transforming the user query into a privacy-aware request and querying the set of secondary agents based on the privacy-aware request.

17. The method of claim 12, further comprising: at a central agent, generating an initial response to the query; and at the primary user agent, refining the initial response to generate the response to the user query.

18. The method of claim 12, wherein each datum of the set of data is associated with a datum-specific privacy level predicted by the set of secondary agents, wherein the set of data is determined by the set of secondary agents based on the datum-specific privacy level.

19. The method of claim 12, wherein the primary user agent restricts data from being viewed by the primary user based on the social proximity value.

20. The method of claim 12, wherein the set of secondary agents determines the set of data, wherein determining the set of data comprises filtering a database comprising data associated with the primary user and secondary users in latent feature space.
